(19) United States
(12) Patent Application Publication
(10) Pub. No.: US 2004/0003134 A1
(43) Pub. Date: Jan. 1, 2004

(54) Software sharing model

(76) Inventors: Eugene S. Lin, Seattle, WA (US); Shawn Edward Maloney, Bellevue, WA (US)

Correspondence Address: RICK D. NYDEGGER, WORKMAN, NYDEGGER & SEELEY, 1000 Eagle Gate Tower, 60 East South Temple, Salt Lake City, UT, 84111, US

(21) Appl. No.: 10/184,354

(22) Filed: Jun. 27, 2002

(51) Int. Cl. G06F 13/10; G06F 9/445

(52) U.S. Cl. 709/321

(57) ABSTRACT

A model for sharing software such as a device driver. After receiving a notification that a consumer computer system is in need of software that has certain criteria, a referral list is consulted to determine an available software item that best meets this need. The consumer computer system is then told of a provider computer system that is capable of providing that software. The consumer computer system may then download that software directly from the provider computer system. In one example, the software is a driver thus allowing a consumer computer system to automatically download an appropriate driver upon connection of an associated hardware device.

### CROSS-REFERENCE TO RELATED APPLICATIONS

N/A

### BACKGROUND OF THE INVENTION

1. The Field of the Invention

The present invention relates to the field of software distribution technology. More particularly, the present invention relates to a model for efficiently sharing drivers.

2. Background and Related Art

Computing technology has transformed the way we work and play. Computers operate by a relatively sophisticated interaction between software and hardware. Software includes computer-executable instructions and data that cause the hardware to perform certain acts. An operating system is software that governs basic functionality that extends across a variety of different applications including, for example, network and inter-device communication, user interface, memory management, and the like. Applications, on the other hand, are software that perform more specific functions and may call upon the basic functionality of the operating system.

The computer also includes hardware in the form of a wide variety of devices. For example, non-volatile memory components such as hard disks, CD-ROMs, DVDs, floppy disks, EEPROMs, and the like, hold information such as software and data, such that the information remains stored when the computer powers down. Volatile memory components such as RAM store run-time information that is ultimately lost once the computer loses power. One or more processors run the computer-executable instructions so as to perform calculations and control other hardware components over a bus. Such processors may include general-purpose processors or special-purpose processors such as graphics processors. Network interface devices such as modems and network cards send and receive information over a network. Displays, printers, and speakers render information to a user so as to be visible and audible to a user. Keyboards, pointing devices, scanners, and cameras allow users to efficiently input information into the computer.

Some of these hardware components require the installation of software in order to communicate in a desired manner with the operating system. Software that facilitates proper communication between a software component (such as the operating system) and a hardware component will be referred to in this description and in the claims as a “driver”. There is a wide variety of different types of hardware devices that may require a driver. Consider, for example, just one of the different types of hardware devices identified above, namely printers. There are a numerous makers, brands, and models of printers. Each model typically requires a particular driver. Furthermore, even a single model of a hardware device usually requires different drivers in order to communicate with different operating systems running on different computer systems. All told, there are literally tens or potentially hundreds of thousands of commercially available drivers for each of the numerous new and existing devices that may be connected to any of a variety of differently configured computers running any of a variety of operating systems.

Finding a device driver for a newly installed device or updating an existing device driver can be an onerous task, particularly for less sophisticated computer users. There are conventional systems and methods that often, but not always, make it easier for a user to find an appropriate driver for a given device. In one conventional method, once the operating system determines the identity of the device, the operating system attempts to find an appropriate driver, as outlined below.

The operating system itself may have access to an appropriate driver via several mechanisms. For example, one mechanism involves the operating system checking for the appropriate driver in a locally-stored repository of drivers that is managed by the operating system. An additional mechanism involves checking for the appropriate driver on a compact disc that came with the purchase of the operating system. If the compact disc is not already in the CD-ROM drive, then the operating system may prompt the user to insert the appropriate compact disc. Often, a floppy disk or compact disc of drivers is included when purchasing a device. More recently, operating systems also may attempt to connect with a specific driver repository Web site for the appropriate driver.

These conventional methods for accessing an appropriate driver generally are helpful. However, there are frequently circumstances in which a driver will be newer than the ship date of the operating system. For example, there is a real possibility that the needed driver may not be in the repository of drivers managed by the operating system, either on the hard disk or on the compact disk. Furthermore, the specific driver repository Web site may not be exhaustive, and may require the permission of the device manufacturer and testing of the driver before the driver is included in the repository Web site. In any case, maintaining a completely exhaustive and up-to-date list of drivers in real-time on a Web site would be a daunting task, if not altogether impossible. In other circumstances, the compact disk that came with the device may be unavailable or out-of-date. Perhaps the compact disk was lost, damaged or destroyed. Accordingly, the operating system may be unable to locate the appropriate driver.

Alternatively, one could search the Internet for a Web site that contains the appropriate driver. For example, for a scanner purchased from a particular vendor, a reasonably experienced user may navigate to the home page of the vender, and attempt to navigate through hyperlinks until an option to download the appropriate driver is presented. However, there may be a number of computer users that may not understand the need for a driver, and even if they understand the need, it may not be practical for them to locate the driver over the Internet. Even for those capable of locating the driver on the Internet, it may take considerable navigation before the appropriate driver is found. And the user ultimately may be disappointed to find that the driver does not work as well as expected, perhaps due to the user's particular hardware configuration, lack of expertise, poor choice in choosing (or a disreputable) Web site, etc.

Furthermore, it may be extremely difficult, if not impossible, to identify an appropriate driver based on the available description of a device. For example, each unique device will have a unique identifier that may be read by the operating system. However, the associated human-friendly description of the device may not be unique at all. There may be a single human-friendly description (or several deceptively similar descriptions) that actually correspond to distinct devices which, although similar, use different drivers for optimal performance. Accordingly, it is not always convenient, practical, or foolproof for users to search the Internet for drivers using some form of human-friendly description.

Accordingly, what is desired are mechanisms for more conveniently and efficiently accessing drivers and other software components.

### BRIEF SUMMARY OF THE INVENTION

The principles of the present invention relate to mechanisms for improving convenience and automation involved with finding appropriate software that meets certain criteria. For example, when a new hardware device is connected to a computer system, the computer system may need a driver to facilitate communication between the operating system and the hardware device. The principles of the present invention allow for an appropriate driver to be located and downloaded in a convenient and automated fashion.

The sharing mechanism may be implemented in a network environment such as the Internet that includes a number of provider computer systems which are capable of providing software modules upon request and a number of consumer computer systems that may have some need for the software modules provided by the provider computer systems.

A referral cloud (e.g., a centralized server system in the form of one or more interconnected server computer systems, one or more peer consumer systems, one or more peer provider systems, etc.) may also be included in the network for facilitating peer-to-peer communications between consumer computer systems and provider computer systems such that a consumer computer system is capable of connecting to an appropriate provider computer system for downloading appropriate software that meets a need of the consumer computer system.

In one embodiment, the referral cloud receives a notification from a software component of the consumer computer system. The notification describes at least a desire for software that meets certain criteria. For example, if a new hardware device is connected to the consumer computer system, the consumer computer system may issue a notification requesting the driver that works best for this device, given the operating system, configuration, usage pattern, etc. of the consumer computer system.

The referral cloud then compares the criteria for the software against a referral list that lists characteristics of software that are available from one or more of the provider computer systems. The referral list may have been compiled by each provider computer system registering, with the referral cloud, their ability to provide new software items. After this comparison, the referral cloud may then return mappings of one of more appropriate software components and their corresponding provider computer systems to the consumer computer system. The consumer computer system then may contact the appropriate provider computer system and request the appropriate software item. For example, the consumer computer system may acquire an appropriate driver for the newly-connected hardware device from one of the provider computer systems.

There are a number of variations from this model. For example, the referral cloud may download the referral list to the consumer computer system, leaving it to the consumer computer system to compare the available software with the specific software need on the consumer computer system. Also, the referral cloud may include not just a reference to the provider computer system that has the software, but may also include the software item itself. In this case, the referral cloud also acts as an archival cloud. The software items may be uploaded by the respective provider computer system at the time the provider computer system contacts the archival cloud to first submit information about the specific software item.

In a more decentralized model, one of the provider computer systems acts as an initial provider computer system that may be contacted by a given consumer computer system. If the initial provider computer system does not have software that meets the need of the consumer computer system, then the initial provider computer system may send a referral list that contains a list of other provider computer systems along with the software items that they are able to provide. The consumer computer system continues checking referral lists from each of the contacted provider computer systems until one of the referral lists identifies a provider computer system that has software that meets the software need of the consumer computer system. The consumer computer system may then download that software from the identified provider computer system.

In one embodiment, the consumer computer system may provide information regarding the performance of the found software component, thus allowing the referral or archival cloud to establish a rating associated with the software item and/or its associated provider computer system. The cloud may include this information in the referral list thereby allowing for the comparison to return only the referrals that will most likely result in a successful installation.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered as limiting its scope, the invention will be described and explained with additional specificity and detail through the use of the accompanying drawings in which:

FIG. 1 illustrates a suitable computing system in which the principles of the present invention may be employed.

FIG. 2 illustrates one suitable network model, referred to as a referral model, that may be used to share software in accordance with the principles of the present invention.

FIG. 3 illustrates a flowchart of a method for sharing software in accordance with the principles of the present invention.

FIG. 4 illustrates a flowchart of a method performed by a software provider computer system in order to facilitate the sharing of a particular item of software in accordance with the principles of the present invention.

FIG. 5 illustrates second suitable network model referred to herein as an archival model that may be used to sharing software in accordance with the principles of the present invention.

FIG. 6 illustrates a third suitable network model referred to herein as a decentralized model that may be used to sharing software in accordance with the principles of the present invention.

### DETAILED DESCRIPTION OF THE PREFERRED EMBODIMENTS

The principles of the present invention relate to mechanisms for sharing software such as drivers in an efficient and automated fashion. After being notified from a software component (e.g., the operating system) of a consumer computer system of a desire for a particular item of software that meets certain criteria, a candidate pool of software is automatically gathered without real-time user intervention. The candidate pool is compared against the certain criteria resulting in one of more of the candidates being returned. The candidates may be gathered by the consumer computer system, or by a server computer system that serves as a referral database listing numerous available items of software with their corresponding characteristics.

Embodiments within the scope of the present invention include computer-readable media for carrying or having computer-executable instructions or data structures stored thereon. Such computer-readable media can be any available media which can be accessed by a general purpose or special purpose computer. By way of example, and not limitation, such computer-readable media can comprise physical computer-readable media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

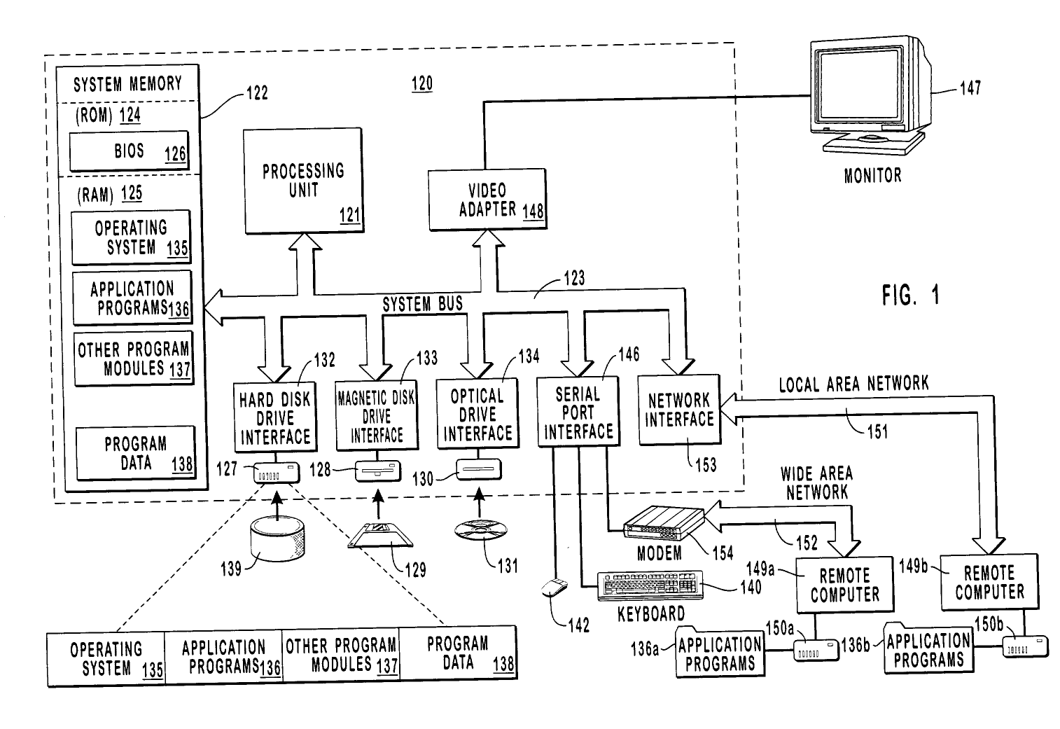

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, and the like, that perform particular tasks or implement particular abstract data types.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

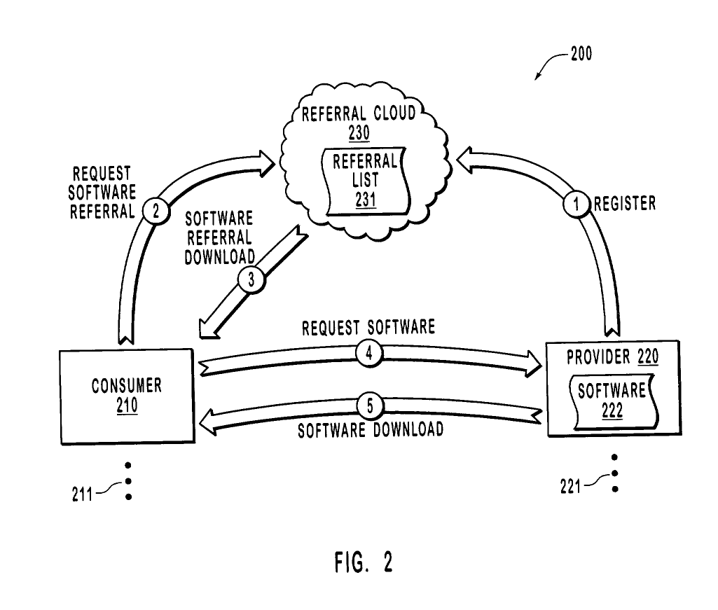

With reference to FIG. 1, an exemplary system for implementing the invention includes a general purpose computing device in the form of a conventional computer 120, including a processing unit 121, a system memory 122, and a system bus 123 that couples various system components including the system memory 122 to the processing unit 121. Throughout this description, element numbers begin with the same number as the figure in which the corresponding elements were first introduced. For example, all of the element numbers in FIG. 1 are numbered in the 100's while the element numbers in FIG. 2 are number in the 200's, and so forth. If the same element is re-illustrated in subsequent drawings, however, the corresponding reference number will remain the same.

The system bus 123 may be any of several types of bus structures including a memory bus or memory controller, a peripheral bus, and a local bus using any of a variety of bus architectures. The system memory includes read only memory (ROM) 124 and random access memory (RAM) 125. A basic input/output system (BIOS) 126, containing the basic routines that help transfer information between elements within the computer 120, such as during start-up, may be stored in ROM 124.

The computer 120 may also include a magnetic hard disk drive 127 for reading from and writing to a magnetic hard disk 139, a magnetic disk drive 128 for reading from or writing to a removable magnetic disk 129, and an optical disk drive 130 for reading from or writing to removable optical disk 131 such as a CD-ROM or other optical media. The magnetic hard disk drive 127, magnetic disk drive 128, and optical disk drive 130 are connected to the system bus 123 by a hard disk drive interface 132, a magnetic disk drive-interface 133, and an optical drive interface 134, respectively. The drives and their associated computer-readable media provide nonvolatile storage of computer-executable instructions, data structures, program modules and other data for the computer 120. Although the exemplary environment described herein employs a magnetic hard disk 139, a removable magnetic disk 129 and a removable optical disk 131, other types of computer readable media for storing data can be used, including magnetic cassettes, flash memory cards, digital video disks, Bernoulli cartridges, RAMs, ROMs, and the like.

Program code means comprising one or more program modules may be stored on the hard disk 139, magnetic disk 129, optical disk 131, ROM 124 or RAM 125, including an operating system 135, one or more application programs 136, other program modules 137, and program data 138. A user may enter commands and information into the computer 120 through keyboard 140, pointing device 142, or other input devices (not shown), such as a microphone, joy stick, game pad, satellite dish, scanner, or the like. These and other input devices are often connected to the processing unit 121 through a serial port interface 46 coupled to system bus 123. Alternatively, the input devices may be connected by other interfaces, such as a parallel port, a game port or a universal serial bus (USB). A monitor 147 or another display device is also connected to system bus 123 via an interface, such as video adapter 148. In addition to the monitor, personal computers typically include other peripheral output devices (not shown), such as speakers and printers.

The computer 120 may operate in a networked environment using logical connections to one or more remote computers, such as remote computers 149a and 149b. Remote computers 149a and 149b may each be another personal computer, a server, a router, a network PC, a peer device or other common network node, and typically include many or all of the elements described above relative to the computer 120, although only memory storage devices 150a and 150b and their associated application programs 136a and 136b have been illustrated in FIG. 1. The logical connections depicted in FIG. 1 include a local area network (LAN) 151 and a wide area network (WAN) 152 that are presented here by way of example and not limitation. Such networking environments are commonplace in office-wide or enterprise-wide computer networks, intranets and the Internet.

When used in a LAN networking environment, the computer 120 is connected to the local network 151 through a network interface or adapter 153. When used in a WAN networking environment, the computer 120 may include a modem 154, a wireless link, or other means for establishing communications over the wide area network 152, such as the Internet. The modem 154, which may be internal or external, is connected to the system bus 123 via the serial port interface 146. In a networked environment, program modules depicted relative to the computer 120, or portions thereof, may be stored in the remote memory storage device. It will be appreciated that the network connections shown are exemplary and other means of establishing communications over wide area network 152 may be used.

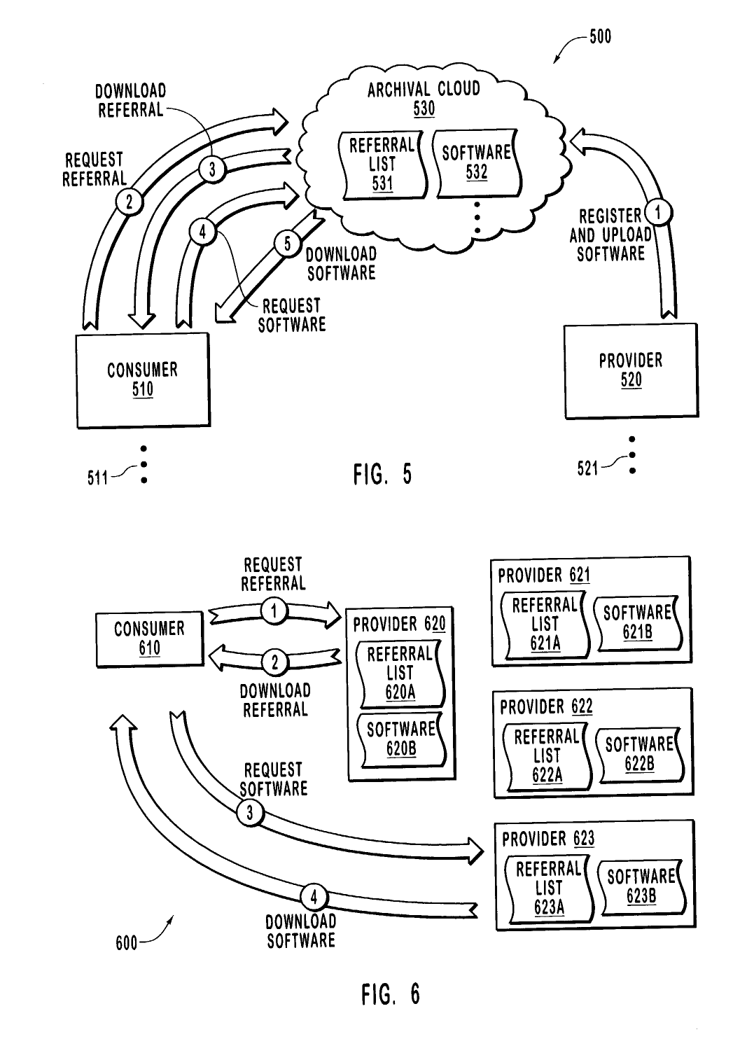

The principles of the present invention related to the sharing of software between provider computer systems and consumer computer systems. There are several models that may be used to share software in accordance with the present invention. FIG. 2 illustrates a sharing model 200 that will be referred to herein as the “referral model.” Other models are illustrated and described with reference to FIGS. 5 and 6.

The referral model 200 includes a number of consumer computer systems including consumer computer system 210 among potentially many others as represented by the vertical ellipses 211. The referral model 200 also includes a number of provider computer systems including provider computer system 220 among potential many others as represented by the vertical ellipses 221. In one embodiment, the consumer computer system 210 and provider computer system 220 are peers in a network of computer systems. It should be noted that the terms “consumer” and “provider” may describe the relationship of the computer systems at a particular instance of time, rather than a permanent or longer-lasting designation. Accordingly, a computer system may act as a consumer at one time and/or as a provider at other times.

The provider computer system 220 provides a specific item of software such as, for example, software 222. The consumer computer system 210 has a desire or need for software such as the software 222. The consumer computer system 210 and the provider computer system 220 may each be structured similar to the computer 120 described above with referenced to FIG. 1. The software 222 may be, for example, any set of computer-executable instructions including, for example, device drivers, application components, service components, etc. In the following description, the sharing of software will be described often with reference to a device driver. However, the principles of the present invention related to the sharing of any software, not just drivers.

The model 200 also includes a referral cloud 230 that includes a referral list 231. The referral list 231 catalogs the available drivers for sharing and, for each driver, provides a mapping of provider computer systems that are capable of providing that driver. The referral cloud 230 may be, for example, a computer system such as computer 120 described above with reference to FIG. 1. However, the referral cloud may also be a network of computer systems that cooperatively interact to facilitate the transfer of software 222 from the provider computer system 220 to computer system 120. Alternatively, all or portions of the referral cloud 230 may be implemented at consumer computer system 210 and/or provider computer system 220.

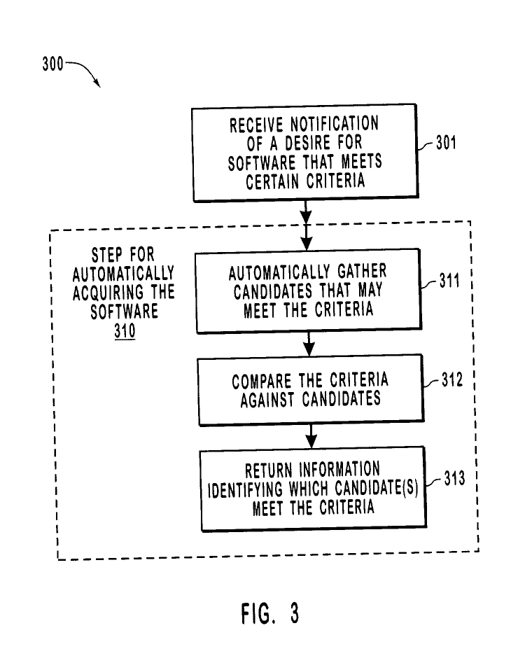

In addition to the elements just described, FIG. 2 also shows five arrows that represent data flow. Each arrow is labeled with circled numbers that overly each particular arrow. The number represents an example sequential order of the data flow represented by the corresponding arrow. FIG. 3 illustrates a method 300 for facilitating the consumer computer system accessing a specific software module in accordance with the principles of the present invention. The method 300 will first be described in the context of the referral model 200 of FIG. 3, although the method 300 may also be applied to the models of FIG. 5 and FIG. 6, and to variations of these models as will be explained in further detail below.

The method 300 includes an act of receiving a notification from a software component of the consumer computer system (act 301). The notification describes at least a desire for software that meets certain criteria. This notification is represented by arrow 2 in FIG. 2. The software component that issued the notification may be, for example, an operating system or an application of the consumer computer system 210. In the case where the consumer computer system is the computer 120, the notifying software component may be the operating system 135, or one of the application programs 136, or one of the other program modules 137.

In one example, the desired software may be, for example, a device driver. After identifying a newly-connected device, the operation system may identify a need for a driver associated with the newly-connected device. The operating system may detect the identity of a newly-connected device by receiving a notification from the device or by querying the device as is the case when a plug-n-play device has just been connected. In cases where the device does not support such notification or querying, the operating system may interrogate the device by sending certain data to the device and monitoring the device's response.

Alternatively, a user could simply manually enter the identity of the device. However, due to the wide-variety of device drivers available, requiring the user to manually identify the corresponding device driver for a newly-connected device can be quite onerous, if not impossible. Additional software may be needed in order to allow a user to manually identify an associated driver. However, by receiving notifications, by querying the device, or by interrogating the device, the operating system may determine the identity of the device that was just connected to the consumer computer system 210.

Accordingly, by automatically identifying the device, the operating system may automatically determine that an associated driver is needed and thus communicate that need to another component of the consumer computing system or to another computer system. In this description and in the claims, “automatically” performing a function means that that function is accomplished without requiring real-time user input or intervention at the time the function is performed. There may, of course, be some configuration or registration input provided by the user before the automated function is performed.

The method 300 also include a step for automatically acquiring the specific software module in response to the notification (step 310). This functional, result-oriented step may include any corresponding acts for accomplishing this purpose. However, in the illustrated embodiment, the step 310 includes corresponding acts 311, 312 and 313.

In particular, the method 300 includes an act of automatically, and without real-time user intervention, gathering a first set of one or more candidates for software that may potentially fulfill at least some of the certain criteria (act 311). For example, the referral cloud 230 has compiled the referral list 231, which represents a first set of one or more candidates for software that may potentially fulfill at least some of the certain criteria. The candidates for software may be listed indirectly by listing all of the provider computer systems 220 or 221, or directly by listing all of the items of software that may be provided by each of the provider computer systems 220 and 221.

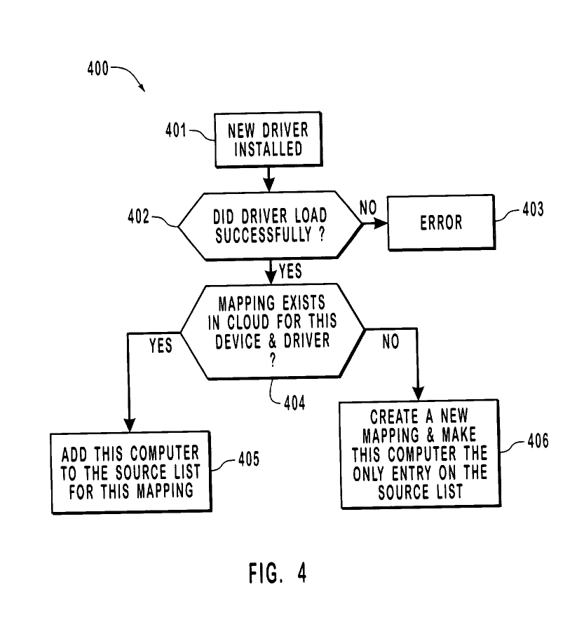

FIG. 4 illustrates a method 400 whereby the referral list 331 may be generated. The referral list 231 may be generated by receiving a number of registrations from individual provider computer systems, the registrations indicating an ability to provide a particular device upon request. In FIG. 2, this registration is illustrated for one of the provider computer systems (namely, provider computer system 220) in the form of arrow 1.

The method 400 may be performed by any of the provider computer systems 220 and 221, any of the consumer computer systems 210 and 211, etc., and shared with or distributed to other computer systems. When a new driver (or other software component) is installed (act 401), the provider computer system determines whether or not the driver was successfully loaded (act 402). If not (NO in act 402), an error has occurred and the provider computer system responds as appropriate for that error. If the driver has successfully loaded (YES in act 402), either the provider computer system (or the referral cloud after appropriate notification) determines whether or not a listing already exists for that specific driver (act 404).

Such a listing may be referred to also as a “mapping” since in one implementation the listing maps the provider computer system to a specific driver or other software module that the provider computer system is able to provide. If a current mapping for this device and driver does not already exists (NO in act 404), then a new mapping is created and the provider computer system is listed as the only provider computer system that is capable of providing the associated device or software module (act 406). If a current mapping for this driver already exists (YES in act 404), the provider computer system is added to the list of provider computer systems that are capable of providing this driver or other software component (act 405). It should be noted that this referral list may be generated well before the notification of the need for software is received.

Referring back to FIG. 3, once the referral cloud 230 receives the notification describing a desire for software that meets certain criteria (act 401), and once the referral cloud ¢ automatically gathers a first set of one or more candidates for software that may potentially fulfill at least some of the certain criteria (act 411) in the form of referral list 231, the referral cloud compares the certain criteria specified in the notification against the referral list (act 413). For example, if the notification specified that the desired software should be a driver compatible with a particular hardware driver, this act of comparing would involve finding one of more drivers listed in the referral list that are appropriate for the designated hardware device.

Once the referral cloud 230 performs this comparison, the referral cloud 230 returns information (act 313) identifying one or potentially several candidates provider computer system that may potentially provide a particular software item that meets the certain criteria originally provided by the consumer computer system in the notification. This returning of information is illustrated in FIG. 2 with arrow 3 representing a software referral download.

The consumer may then use the referral information to then establish a connection with one of the provider computer systems if a connection is not already established, and then submit a request for the particular software item to the provider computer system. For example, in FIG. 2, the consumer computer system 210 makes a request to the provider computer system 220 for the software 222 as represented by arrow 4. The provider computer system 220 then sends the software 222 to the provider computer system 210 as represented by arrow 5.

In the above-described model 200, the method 300 was performed by the consumer computer system performing the act of notifying, and by the referral cloud 230 performing the acts of gathering, comparing and returning. However, all of the acts of notifying, gathering, comparing, and returning may instead be performed by the consumer computer system 310.

The act of receiving a notification from a software component of the consumer computer system (act 301) may be performed by the operating system or any application within the consumer computer system 210 that is capable of assessing a desire or need for another software component that meets the certain criteria. Another software component(s) within the consumer computer system 210 may then perform the remaining acts of the method 300. In particular, the consumer computer system 210 itself may automatically gather a first set of one or more candidates for software that may potentially fulfill at least some of the certain criteria (act 311) by, for example, request and downloading the entire referral list 231 from the referral cloud 230. The consumer computer system 210 itself, rather than the referral cloud, then compares the certain criteria against the referral list (act 312), and then returns information identifying a set of one or more candidates from the referral list based on the comparison to the software module that issued the notification. In this case, the returning act occurs within the consumer computer system between software modules. The consumer computer system 210 may then retrieve the desired software module from the provider computer system 220 as described above with respect to arrows 4 and 5 of FIG. 2.

FIG. 5 illustrates a software sharing module 500 called herein the “archival model”. The archival model is similar to the referral model described above with respect to FIG. 2 with differences now pointed out. In particular, note that in addition to the provider computer system 520 registering the suitability of the software module 532 for use in certain context, the computer system 520 also uploads the software module 532 to the archival cloud 530. (Of course, all or portions of the archival cloud 530 may be implemented at consumer computer system 510 and/or provider computer system 520.)

The archival cloud receives the notification for desired software (act 301 and arrow 2 of FIG. 5), compares the criteria specified in the notification with the referral list 531 (act 311), and returns the referral that is based on the comparison (act 312 and arrow 3 of FIG. 5). The consumer computer system 510 requests the software 532 specified in the referral from the archival cloud 530, rather from some other provider computer system. In one alternative embodiment, the archival cloud 530 may provide the actual software specified in the referral immediately to the consumer computer system 510 along with the referral rather than waiting for an addition request from the consumer computer system 510.

FIG. 6 illustrates a software sharing model called herein the “decentralized model” since there are no server or cloud of servers needed to maintain a centralized referral list. Instead, each provider computer system 620 through 623 has its own referral list 620A through 623A respectively, and its own software repository 620B through 623B respectively. In this model, the provider computer system 620 may be viewed as an initial archival cloud such as the archival cloud 530 described above with respect to FIG. 5. However, in the case of the decentralized model, the referral list 620A of the provider computer system 620 would be much less comprehensive than the referral list 531 of the archival cloud 530.

A software module (such as an operating system or another application) within the consumer computer system 610 notifies another application within the consumer computer system 610 of the need for a software module that meets certain criteria (act 301). The consumer computer system 610 then requests a referral from the provider computer system 620 (arrow of FIG. 6). The provider computer system 620 then returns the referral list 620A to the consumer computer system 610 (arrow 2 of FIG. 6). Since the referral list 620A may be relatively small, returning the entire list may be practical. However, in some cases, the consumer computer system 610 may also specify the specific criteria for the software to meet in the request for the referral list 620A. In that case, the provider computer system 620 may do some filtering and return only a portion of the referral list 620A.

In any case, suppose that the referral list 620A (or the returned portion thereof) contains a list of software that the initial provider computer system 620 may provide, as well as a list of software that three other provider computer systems including provider computer systems 621 through 623 may provide. After comparing the referral list 620 (or portion thereof) with the certain criteria desired of a software module, the consumer computer system 620A determines if any of the provider computer systems 620 through 623 contain software that meet the certain criteria. In the illustrated example, provider computer system 623 contains a software module 623B that meets the criteria. Accordingly, the consumer 610 requests the software module 623B from the provide computer system 623. If the referral list 620A did not list that any of the initial provider computer system 620 nor any of the second-tier provider computer systems 621 through 623 contained software that met the certain criteria, the consumer computer system 610 may then begin requesting and obtaining referral lists 621A through 621C from the second-tier provider computer systems 621 through 623 to see if they indicate that any third-tier provider computer systems (not shown) have software that would meet the desired criteria.

In each of these three sharing models discussed above, the principles of the present invention allow the introduction of ratings into the software sharing model. In particular, when a consumer computer system installs a software item received from a given provider computer system, the consumer computer system may evaluate the performance of the software item, and automatically report back to the referral or archival cloud regarding the performance. The cloud may then adjust ratings corresponding to the provider computer system and/or corresponding to the specific software item. This performance information may be gathered from many different consumer computer systems so as to obtain a fairly comprehensive view of the trustworthiness of the provider computer system, and the suitability of the software item for particular environments and configurations. Accordingly, ratings for given provider computer systems or software items may be automatically compiled.

The users of the consumer computer systems that install a particular software item from a particular provider computer system may also give manual ratings by, for example, filling out an electronic survey form and submitting that form to the referral or archival cloud. The cloud itself may also test particular software items to determine how they perform, and then affect a rating for that software item to reflect the results of the test. In some cases, the cloud may only provide referrals from provider computer systems that have been properly authenticated. For example, the referral list may provide device drivers from well-established and trusted peripheral device manufacturers.

The ratings may also differ for different software components depending on the intended operating environment. For example, in the case where the cloud (rather than the consumer computer system) is comparing the certain criteria specified in the notification to the referral list, the notification from the consumer computer system to the cloud may specify the operating system version and usage patterns applicable to the consumer computer system. Alternatively, the consumer computer system may have previously registered with the cloud so that the cloud has predetermined knowledge of the consumer computer system's operating system and usage patterns. The cloud may then determine which of the software items are best considering the operating system version and considering the usage patterns. Similarly, such a comparison may be made by the consumer computer system after having downloaded a referral list, either from the cloud as in the referral model and the archival model, or from another provider computer system(s) as in the decentralized model.

The cloud may keep track of which software modules have been downloaded to consumer computer systems, and notify those consumer computer system when a better (or more updated) version of the software becomes available from one or more of the provider computer systems. For example, when sharing device drivers, the cloud may notify the consumer computer system when a driver becomes available that has a better rating for a given operating system, usage pattern, and device, than a device driver that was previously downloaded to the consumer computer system. Also, should the rating of a particular previously-downloaded device driver drop below a particular level, then the cloud may issue a warning notification to the consumer computer system that downloaded the device driver.

In this manner, sharing of software is facilitated in a more automated and efficient manner, without requiring that users manually search for device drivers. In addition, ratings may allow for the downloading of better drivers without requiring that each consumer computer system test the driver for themselves. Instead, the collective knowledge of all of the consumer computer systems may be harnessed. Accordingly, the principles of the present invention will allow more people more access to more software such as drivers with minimal, if any, human effort.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computer network that includes a plurality of computer systems including a set of at least one provider computer system that is configured to provide software, and a set of at least one consumer computer system that is configured to use software, the set of provider computer systems including a provider computer system that is configured to provide or previously provided a specific software module, the set of consumer computer systems including a consumer computer system that is configured to use the specific software module, a method for facilitating the consumer computer system accessing the specific software module, the method comprising the following:
an act of gathering a first set of one or more candidates for providing one or more software modules to one or more consumer computer systems;
an act of receiving a notification from a software component of the consumer computer system, the notification describing at least a desire for software that meets certain criteria;
an act of comparing the certain criteria against the first set of one or more candidates; and
an act of returning information identifying a second set of one or more candidates from the first set of one or more candidates based on the comparison, the second set of one or more candidates including at least one candidate capable of providing the specific software module.

2. A method in accordance with claim 1, wherein the method is performed by the consumer computer system.

3. A method in accordance with claim 1, wherein the network further includes a centralized server system, wherein the method is performed collaboratively by both the consumer computer system and the centralized server system, wherein the centralized server system performs the acts of gathering, comparing and returning.

4. A method in accordance with claim 3, wherein the act of gathering the first set of one or more candidates comprises the following:
an act of the centralized server system receiving a notification from the provider computer system that the specific software module has certain characteristics.

5. A method in accordance with claim 4, wherein the act of gathering the first set of one or more candidates comprises the following:
an act of the provider computer system providing the specific software module to the centralized server system.

6. A method in accordance with claim 4, wherein the act of gathering the first set of one or more candidates comprises the following:
an act of the provider computer system indicating to the centralized server that the provider computer system is capable of providing the specific software module upon request.

7. A method in accordance with claim 1, further comprising the following:
an act of communicating with the provider computer system; and
an act of acquiring the specific software module as a result of communicating with the provider computer system.

8. A method in accordance with claim 1, wherein the acts of gathering and comparing occur automatically, and without real-time user intervention by the consumer computer system.

9. A method in accordance with claim 1, wherein the consumer computer system and the provider computer systems are peers within the computer network.

10. A method in accordance with claim 1, wherein the information identifying the second set of one or more candidates includes information for rating at least one of the one or more candidates.

11. A method in accordance with claim 1, wherein the software component from which the notification is received is an operating system.

12. A method in accordance with claim 1, wherein the software component from which the notification is received is an application.

13. In a computer network that includes a plurality of computer systems including a set of provider computer systems that are configured to provide software, and a set of one or more consumer computer systems that are configured to use software, the set of provider computer systems including a provider computer system that is configured to provide or previously provided a specific software module, the set of consumer computer systems including a consumer computer system that is configured to use the specific software module, a method for facilitating the consumer computer system accessing the specific software module, the method comprising the following:
an act of receiving a notification from a software component of the consumer computer system, the notification describing at least a desire for software that meets certain criteria; and
a step for automatically acquiring the specific software module in response to the notification.

14. A method in accordance with claim 13, wherein the step for automatically acquiring the specific software module in response to the notification comprises the following:
an act of automatically, and without real-time user intervention, gathering a first set of one or more candidates for software that may potentially fulfill at least some of the certain criteria;
an act of comparing the certain criteria against the first set of one or more candidates; and
an act of returning information identifying a second set of one or more candidates from the first set of one or more candidates based on the comparison, the second set of one or more candidates including at least one candidate capable of providing the specific software module.

15. A computer program product for use in a computer network that includes a plurality of computer systems including a set of provider computer systems that are configured to provide software, and a set of one or more consumer computer systems that are configured to use software, the set of provider computer systems including a provider computer system that is configured to provide or previously provided a specific software module, the set of consumer computer systems including a consumer computer system that is configured to use the specific software module, the computer program product for implementing a method for facilitating the consumer computer system accessing the specific software module, the computer-program product comprising one or more computer-readable media having stored thereon the following:
computer-executable instructions for detecting the receipt of a notification from a software component of the consumer computer system, the notification describing at least a desire for software that meets certain criteria;
computer-executable instructions for gathering a first set of one or more candidates for software that may potentially fulfill at least some of the certain criteria;
computer-executable instructions for comparing the certain criteria against the first set of one or more candidates; and
computer-executable instructions for causing to be returned information identifying a second set of one or more candidates from the first set of one or more candidates based on the comparison, the information identifying at least one candidate capable of providing the specific software module.

16. The computer program product in accordance with claim 15, wherein the one or more computer-readable media are physical storage media.

17. In a computer network that includes a plurality of computer systems including a set of provider computer systems that are configured to provide software, and a set of one or more consumer computer systems that are configured to use software, the set of provider computer systems including a provider computer system that is configured to provide or previously provided a specific software module, the set of consumer computer systems including a consumer computer system that is configured to use the specific software module, the computer network also comprising a server that facilitates the consumer computer system accessing the specific software module, a method for facilitating the consumer computer system accessing the specific software module, the method comprising the following:
an act of the server receiving a notification from the consumer computer system describing at least a desire for software that meets certain criteria;
an act of the server automatically, and without real-time user intervention, gathering a first set of one or more candidates for software that may potentially fulfill at least some of the certain criteria;
an act of the server comparing the certain criteria against the first set of one or more candidates; and
an act of the server returning information to the consumer computer system, the information identifying a second set of one or more candidates from the first set of one or more candidates based on the comparison, the information identifying at least one candidate capable of providing the specific software module.

18. A method in accordance with claim 17, wherein the act of comparing occurs automatically, and without real-time user intervention.

19. A method in accordance with claim 17, wherein the act of returning occurs automatically, and without real-time user intervention.

20. A method in accordance with claim 17, wherein the consumer computer system and the provider computer systems are peers within the computer network.

21. A method in accordance with claim 17, wherein the act of gathering comprises the following:
an act of receiving from the provider computer system information indicating that the specific software module has particular characteristics.

22. A method in accordance with claim 21, wherein the information comprises an indication that the specific software module is a driver that works with a particular device.

23. A method in accordance with claim 22, wherein the information comprises an indication that a particular operating system is running on the provider computer system.

24. A method in accordance with claim 23, wherein the act the server comparing the certain criteria against the first set of one or more candidates comprises the following:
an act of determining whether the provider computer system has the same particular operating system as the consumer computer system.

25. A method in accordance with claim 22, wherein the information comprises information regarding usage patterns of the provider computer system is used.

26. A method in accordance with claim 25, wherein the act the server comparing the certain criteria against the first set of one or more candidates comprises the following:
an act of determining whether the provider computer system has comparable usage patterns as the provider computer system.

27. A method in accordance with claim 17, wherein the server further performs the following:
an act of maintaining a rating associated with at least some of the provider computing systems.

28. A method in accordance with claim 27, wherein the referral list only includes those provider computing systems that have a certain minimum rating.

29. A method in accordance with claim 17, wherein the server further performs the following:
an act of maintaining a rating associated with the specific software module.

30. A method in accordance with claim 29, wherein the server further performs the following:
an act of testing the specific software module; and
an act of setting the rating at least based on the results of the act of testing.

31. A method in accordance with claim 29, wherein the server further performs the following:
an act of receiving feedback from the set of consumer computer systems regarding the performance of the specific software module; and
an act of setting the rating at least based on the feedback from the set of consumer computer systems.

32. A computer program product for use in a computer network that includes a plurality of computer systems including a set of provider computer systems that are configured to provide software, and a set of one or more consumer computer systems that are configured to use software, the set of provider computer systems including a provider computer system that is configured to provide or previously provided a specific software module, the set of consumer computer systems including a consumer computer system that is configured to use the specific software module, the computer network also comprising a server that facilitates the consumer computer system accessing the specific software module, the computer program product for implementing a method for facilitating the consumer computer system accessing the specific software module, the computer program product comprising one or more computer-readable media having stored thereon the following:
computer-executable instructions for detecting the receipt of a notification from the consumer computer system describing at least a desire for software that meets certain criteria;
computer-executable instructions for gathering a first set of one or more candidates for software that may potentially fulfill at least some of the certain criteria;
computer-executable instructions for comparing the certain criteria against the first set of one or more candidates; and
computer-executable instructions for returning information to the consumer computer system, the information identifying a second set of one or more candidates from the first set of one or more candidates based on the comparison, the information identifying at least one candidate capable of providing the specific software module.

33. The computer program product in accordance with claim 32, wherein the one or more computer-readable media are physical storage media.

34. A computer program product for use in a computer network that includes a plurality of computer systems including a set of provider computer systems that are configured to provide software, and a set of one or more consumer computer systems that are configured to use software, the set of provider computer systems including a provider computer system that is configured to provide or previously provided a specific software module, the set of consumer computer systems including a consumer computer system that is configured to use the specific software module, the computer network also comprising a server that facilitates the consumer computer system accessing the specific software module, the computer program product for implementing a method for facilitating the consumer computer system accessing the specific software module, the computer program product comprising one or more computer-readable media having stored thereon the following:
computer-executable instructions for causing a first request for software that meets certain criteria to be issued, wherein the specific software module meets the certain criteria;
computer-executable instructions for detecting the receipt of candidate provider computer systems that may potentially be able to supply the specific software module;
computer-executable instructions for issuing a second request to one of the candidate provider computer systems for the specific software module; and
computer-executable instructions for detecting the receipt of the specific software module from the candidate provider computer system that the second request was issued to.

35. The computer program product in accordance with claim 34, wherein the one or more computer-readable media are physical storage media.

36. The computer program product in accordance with claim 34, wherein the one or more computer-readable media further have stored thereon the following:
computer-executable instructions for installing the specific software module; and
computer-executable instructions for generating a report regarding the performance of the specific software module.

37. The computer program product in accordance with claim 36, wherein the computer-executable instructions for causing a first request for software that meets certain criteria to be issued comprises the following:
computer-executable instructions for causing the first request to be issued to the candidate provider computer system that the second request was issued to.

38. The computer program product in accordance with claim 36, wherein the one or more computer-readable media further have stored thereon the following:
computer-executable instructions for causing the report to the issued to the candidate provider computer system.

39. The computer program product in accordance with claim 36, wherein the computer-executable instructions for causing a first request for software that meets certain criteria to be issued comprises the following:
computer-executable instructions for causing the first request to be issued to a server other than the candidate provider computer system that the second request was issued to.

40. The computer program product in accordance with claim 36, wherein the one or more computer-readable media further have stored thereon the following:
computer-executable instructions for causing the report to the issued to the server.
